(19) United States
(12) Patent Application Publication
(10) Pub. No.: US 2017/0001157 A1
(43) Pub. Date: Jan. 5, 2017

(54) Lid closure for a beverage container

(71) Applicant: Jean Paul Gonzalez-Santini, Ponce, PR (US)

(72) Inventor: Jean Paul Gonzalez-Santini, Ponce, PR (US)

(21) Appl. No.: 15/184,134

(22) Filed: Jun. 16, 2016

Related U.S. Application Data
(60) Provisional application No. 62/180,367, filed on Jun. 16, 2015.

(51) Int. Cl. B01F 13/00; B65D 43/02; B65D 51/32; B65D 51/28

(52) U.S. Cl. CPC B01F 13/0022; B65D 51/2878; B65D 43/02; B65D 51/32; B01F 2215/0022

(57) ABSTRACT

A lid closure for storing and dispensing at least one material into a hot or cold beverage container comprising a one-piece molded lid closure with one or more sealed compartments containing one or more materials, and a stirring element integrally molded to the lid, wherein the sealing floor of the compartments is broken by pulling the stirring element and therefore, the materials are dispensed to the beverage container, where they are then mixed with the stirring element to provide an instant beverage, preferably instant coffee.

### CROSS-REFERENCE TO RELATED APPLICATION

N/A

### STATEMENT REGARDING FEDERALLY SPONSORED RESEARCH AND DEVELOPMENT

N/A

### BACKGROUND OF THE INVENTION

Field of the Invention

The present disclosure relates to a lid comprising at least one or more compartments for storing one or more materials, such as coffee or cremora, to be dispensed into a beverage container by breaking the sealing floor of said compartments by a consumer. The materials dispensed to the beverage container are then mixed with a stirring element to produce an instant beverage, preferably instant coffee.

Discussion of the Background

A lid closure for dispensing materials into a hot or cold beverage container comprises one or more sealed compartments containing materials had been disclosed in U.S. Pat. No. 3,326,363 to Bennett et al and U.S. Pat. No. 6,976,578 to Kenihan. Both public documents disclose the use of plastic lid closures for sealing beverage containers comprising pockets or compartments in molded plastic lid closures that contain materials, such as powdered cream or sugar, for use by a consumer to dispense into a container of a beverage tea or coffee to which the lid closure is secured. Further, Kenihan discloses a complex lid closure forming one or more closed compartments adapted to contain liquid or solid materials, and molded or formed conical depressions or recesses in each arcuate section, wherein each recess forms a downwardly pointed element for puncturing the sealing layer and releasing the material in a respective compartment into the container. The use of multiple downwardly pointed-element to open each chamber separately makes the structure complex and expensive. Further some mixtures required stirring after the material are combined which cannot be completed without a stirring element.

Therefore, it would be desirable to provide a lid closure adapted to store and dispense materials inside one or more separate compartments by removing a stirring element integrally molded to said lid.

### SUMMARY OF THE INVENTION

In light of the above shortcomings of the current structures available, the present disclosure comprises a lid with at least one or more compartments containing at least one material, such as coffee and cremora, a stirring element integrally molded to said lid wherein said stirring element, when pulled, is configured to break the sealing floor of the compartments in such way that the materials are dispensed into a beverage container to be then mixed with the stirring element to provide an instant beverage, preferably instant coffee.

Another object of the present disclosure is to provide a stirring element comprising a pulling mechanism for removing the sealing floor of all the compartments of the lid by pulling a single element.

Further, another object of the present disclosure is to provide a non-expensive simple way to package and prepare an instant beverage, preferably instant coffee.

Further, another object of the present disclosure is to provide a non-expensive simple structural modification in current lids.

Yet another object of the present disclosure is to provide a removable stirring element for stirring the combined materials.

To enable a better understanding of the objectives and features of the present invention, a brief description of the drawing below will be followed with a detailed description of the invention.

### BRIEF DESCRIPTION OF THE DRAWINGS

The accompanying drawings, which are incorporated herein, constitute part of the specifications and illustrate the preferred embodiment of the disclosure.

FIG. 1 is a general view of an exemplary structure for the lid closure for beverage container in accordance with the principles of the current disclosure.

FIG. 2A-2B are views of an exemplary structure for the lid closure for beverage container in accordance with the principles of the current disclosure.

FIG. 3 is an exploded top view of an exemplary structure for the inner lid closure system in accordance with the principles of the current disclosure.

FIGS. 4A-4C are exemplary views of the breaking process of the compartment-sealing floor in accordance with the principles of the current disclosure.

FIG. 5 is an exemplary top view of the compartment-sealing floor broke by pulling the stirring element in accordance with the principles of the current disclosure.

FIGS. 6A-6B are exemplary views of the removing process of the compartment-sealing floor in accordance with the principles of the current disclosure.

FIGS. 7A-7B are views of additional exemplary structure for the lid closure for beverage container in accordance with the principles of the current disclosure

FIGS. 8A-8B are exemplary views of the breaking process of the compartment-sealing floor for the second exemplary inner lid in accordance with the principles of the current disclosure.

FIGS. 9A-9B are exemplary views of the breaking process of the compartment-sealing floor for the third exemplary inner lid in accordance with the principles of the current disclosure.

FIG. 10 is an exemplary top view of the compartment-sealing floor by pulling the stirring element in accordance with the principles of the current disclosure while the material is combined.

### DETAILED DESCRIPTION OF THE INVENTION

The term “material or materials” means liquid or solid materials to prepare an instant beverage such as coffee, cremora, sugar powder, tea, chocolate, water and others.

FIG. 1 is directed to an exemplary structure 1 for the lid closure 3 for beverage container 4 in accordance with the principles of the current disclosure. The exemplary structure 1 comprises a lid closure 3 including a lid recess and a stirring element 2, wherein said lid 3 is used to cover the container 4 opening. The lid 3 in combination with a sealing mechanism formed at least a first compartment 21 and a second compartment 22. The lid is made preferably of plastic.

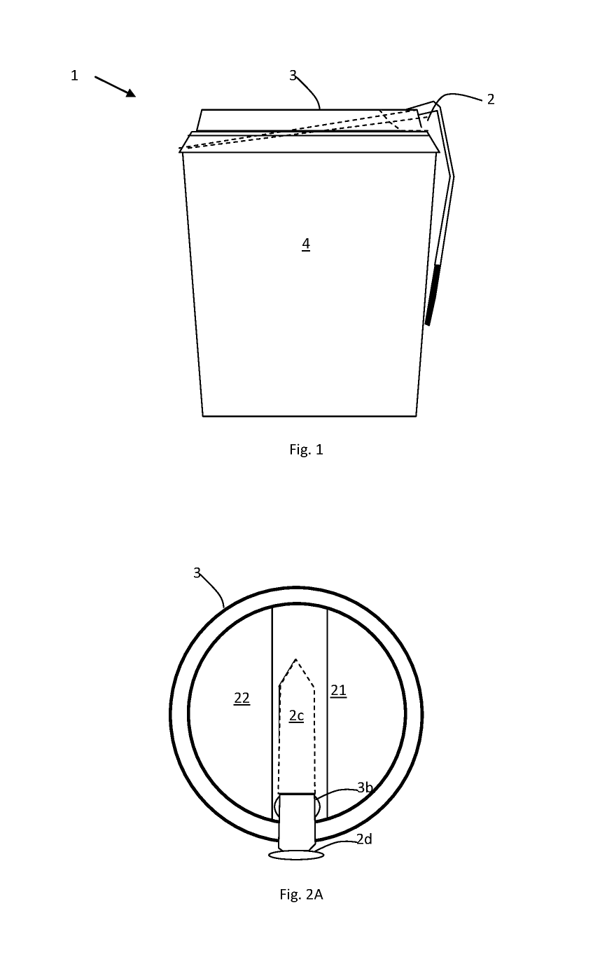

As shown in FIG. 2A through 2B, each compartment 22, 21 comprise part of the lid inner walls perimeters, a sealing floor 2a and a sealing wall 3a. The sealing mechanism, more particularly the sealing floor 2a and a sealing wall 3a are mechanically coupled to the stirring element 2. The stirring element 2 comprises a main elongated body 2c and a distal end, wherein said main elongated body 2c is coupled to the sealing mechanism, more particularly the sealing floor 2a. Each compartment is filled with at least two materials F1,F2. The stirring element 2 may be configured to be shaped as a spoon.

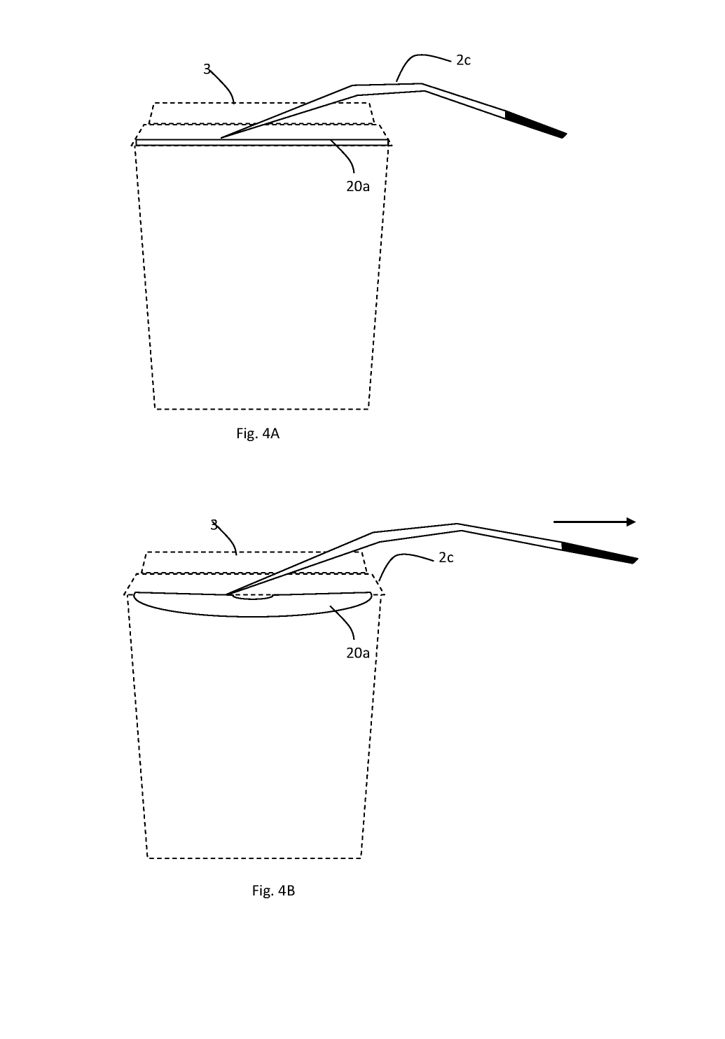

As shown in FIG. 2B, the sealing floor 2a and sealing walls are configured to avoid the materials F1,F2 to escape from compartments 21, 22 and mixed. The sealing floor 2a is attached to the lid inner wall perimeters and the sealing walls 3a extend between the top lid inner upper end toward the sealing floor 2a. FIG. 4 discloses an exemplary view of the sealing mechanism without the lid 3. It is clearly show that the stirring element is attached to the sealing floor 2a, wherein said sealing floor 2a comprises at least two sealing wings 20a. The sealing walls 3a are on top of the sealing floor 2a in order to create a chamber for fluids F1,F2 in combination with the lid closure inner walls.

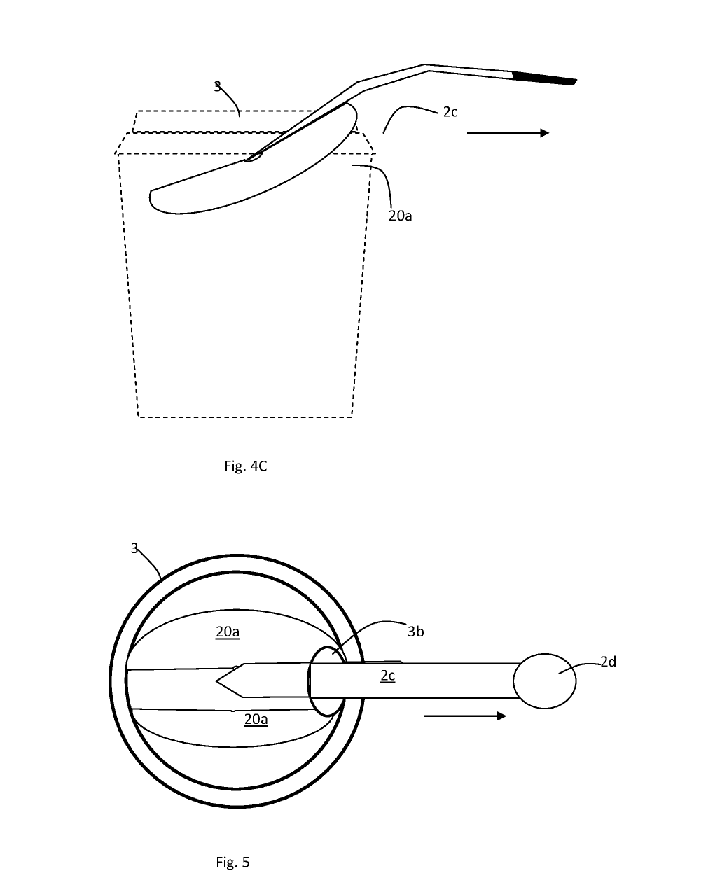

FIGS. 4A-4C are exemplary views of the breaking process of the compartment seals in accordance with the principles of the current disclosure. The main elongated body 2c, which is made of a resilient material strong, such as plastic, enough to assist the opening of the sealing mechanism when it is pulled by user without breaking into pieces. First the main elongated body 2c is partially aligned with the lid recess 3b in order to provide an exit to the main elongated body 2c while it is pulled out. While the main elongated body 2c is pulled out the sealing wings detached from the lids inner walls letting the material F1,F2 to drain into the container 4. The farther the main elongated body 2c is pulled away from the lid 3 the more the sealing wings 20a detached from the inner lid walls until it is completely detached as shown in FIG. 5.

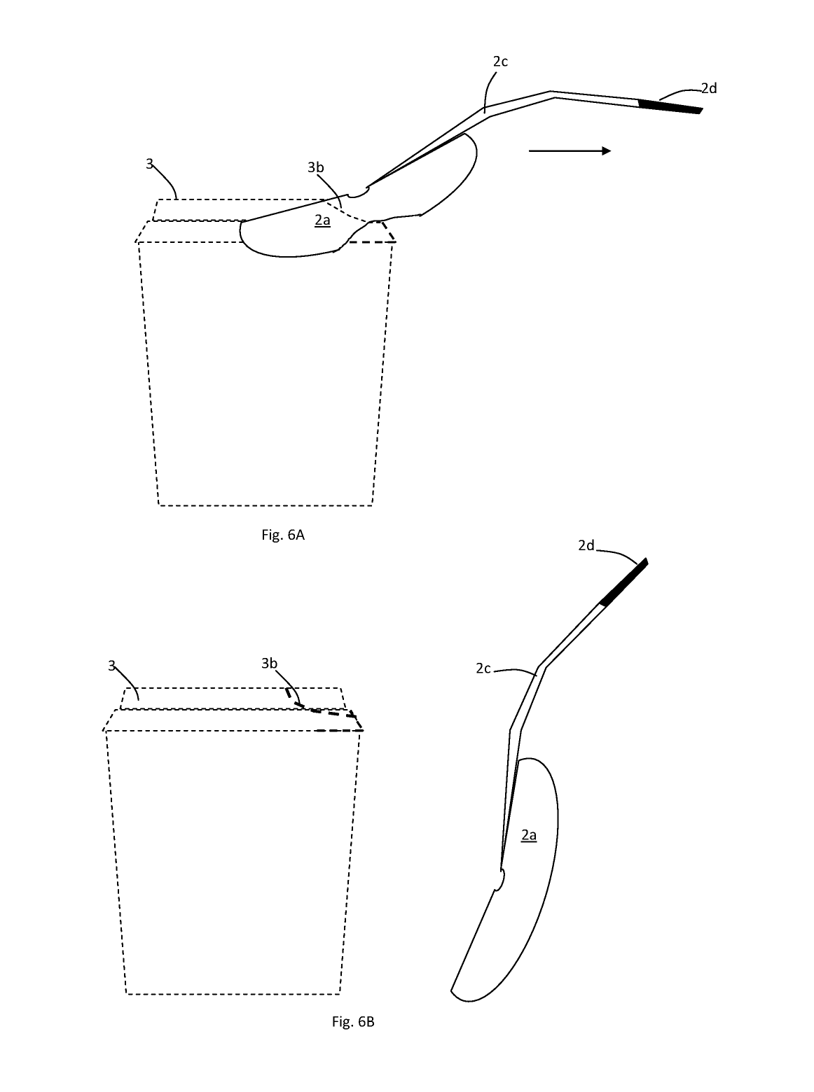

FIGS. 6A-6B are directed to removing the sealing mechanism from the lid 3 through the lid recess 3b. As shown the sealing floor 2a is detached from the lids inner walls by pulling the stirring element 2. Once the sealing floor 2a is detached the user pulls out the sealing mechanism from the lid 3. It is important to understand that the sealing mechanism, more particularly the stirring element attached to the sealing mechanism is used to stir the materials at the container 4.

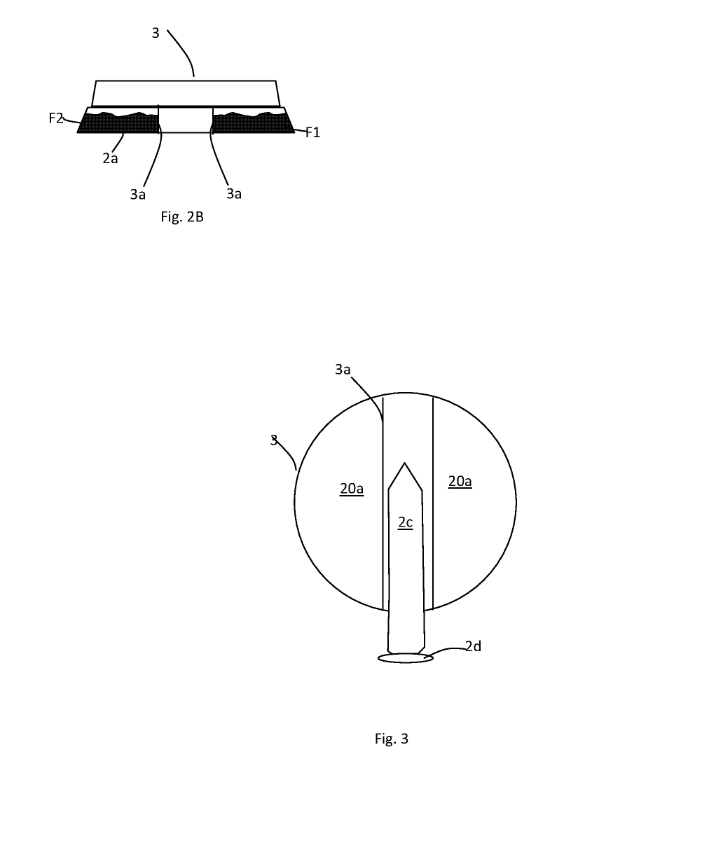

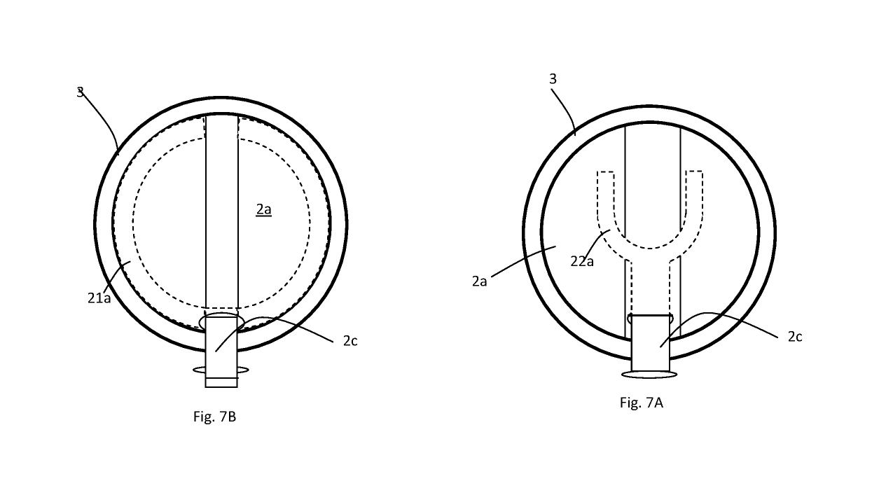

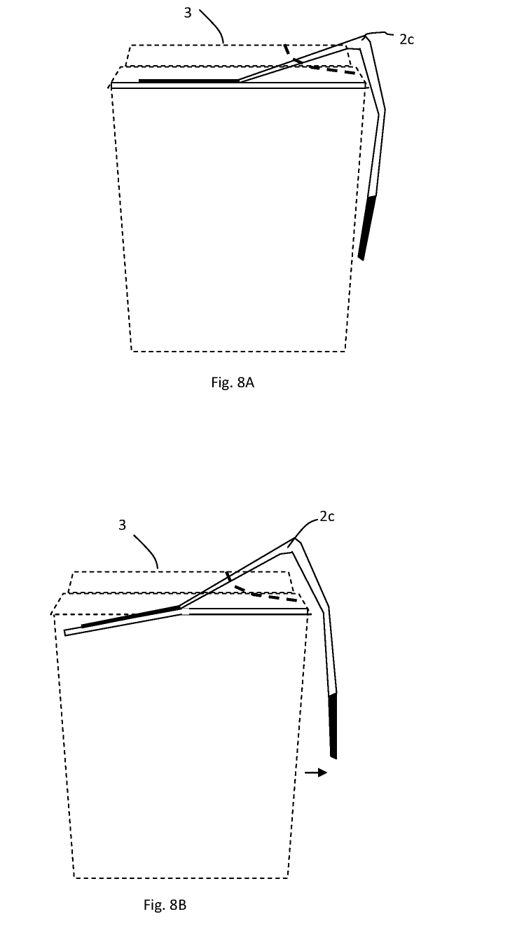

FIGS. 7A and 7B are directed to a second exemplary inner lid closure and a third exemplary inner lid closure respectively comprising a basic inner lid closure as shown in FIG. 2B comprising a sealing floor 2a and walls 3a, as explained in FIG. 3. The second exemplary inner lid closure comprises at least a U-like configuration 22a at the end of the main elongated body 2c coupled to a sealing floor 2a as shown in FIG. 7A. As disclose above, by pulling the stirring element away from the lid 3, the sealing floor 2a detaches from the inner walls of the lid 3. The U-like configuration 22a assists to open each of the chambers during the process of removing the sealing mechanism. The U-like configuration 22a comprises a more rigid structure than the sealing floor 2a in such way that the force exerted on the main elongated body 2c during the breaking seal process, as part of the process of removing the sealing mechanism, is transmitted to the sealing floor 2a. FIGS. 8A and 8B clearly shows the connection between the U-like configuration 22a and the sealing floor 2a. FIG. 8B discloses the breaking seal process before the sealing mechanism is removed. Due to the angle of the stirring element 2 configuration, more particularly the angle, the main elongated body contact the lid and the main elongated body 2c works as a lever. The more rigid structure of the U-like configuration 22a assist with the breaking process of the sealing floor 2a. It should be understood that the more rigid structure may be accomplished by providing a more thick area at the U-like configuration 22a of the same material used for the sealing floor 2a or main elongated body 2c. Further other material with a more rigid characteristic, when it is compared to the sealing floor 2a or main elongated body 2c, may be used.

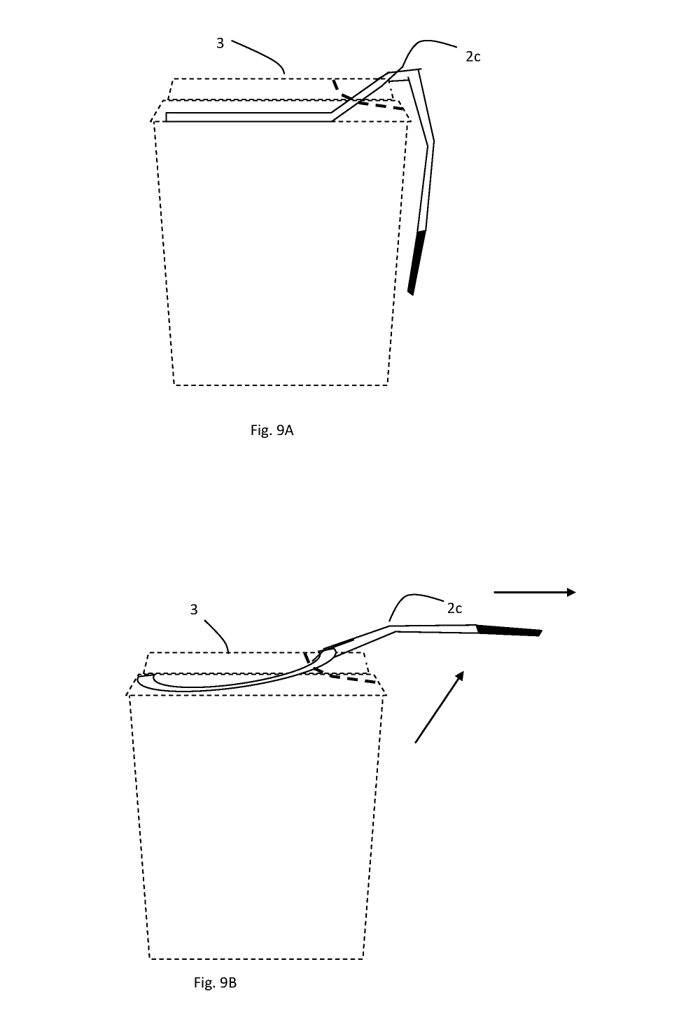

FIG. 7B is directed to the third exemplary inner lid closure. The third exemplary inner lid closure comprises at least a semicircular border configuration 21a coupled to the main elongated body 2c and the sealing floor 2a. Similar as disclose above, by pulling the stirring element 2 away from the lid 3, the sealing floor 2a detaches from the inner walls of the lid 3. The semicircular border configuration 21a assists to open each of the chambers during the process of removing the sealing mechanism. While the main elongated body 2c is pulled out the sealing floor 2a detaches from the lid by separating or disconnecting the semicircular border configuration 21a from the lids inner walls. The farther the main elongated body 2c is pulled away from the lid 3 the more the semicircular border configuration 21a detaches from the inner lid walls as shown in FIGS. 9A and 9B. The semicircular border configuration 21a comprises a more rigid structure than the sealing floor 2a in such way that the force exerted on the main elongated body 2c as part of the process of removing the sealing mechanism, is transmitted to the sealing floor 2a without breaking into pieces.

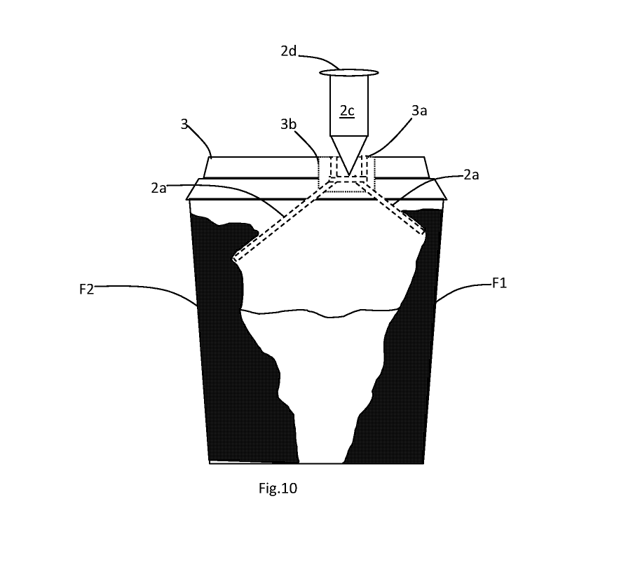

FIG. 10 is an exemplary view of sealing mechanism being detached from the lids inner walls by pulling the stirring element in accordance with the principles of the current disclosure while the material F1,F2 are drained to the container 4. As shown the container may have a hot or cold third material F3 which is combined with the materials F1,F2 from the compartments 21,22. Further, as mentioned above, the stirring element is used to assist mixing the materials F1,F2,F3 at the container 4.

In summary of the previous sections, the disclosure presented here is structurally innovative, presents advantages not available at the moment with existing courts, complies with all new patent application requirements and is hereby lawfully submitted to the patent bureau for review and the granting of the commensurate patent rights.

While the disclosure has been described as having a preferred embodiment, it is understood that many changes, modifications, variations and other uses and applications of the subject disclosure will, however, become apparent to those skilled in the art without materially departing from the novel teachings and advantages of this disclosure after considering this specification together with the accompanying drawings. Accordingly, all such changes, modifications, variations and other uses and applications which do not depart from the spirit and scope of the disclosure are deemed to be covered by this disclosure as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A lid for a container comprising:
a lid including:
a first main body, a container adaptable surface, a top surface including a lid recess, a detachable floor surface, and at least a first internal wall,
wherein said wall extends from said detachable floor surface towards said top surface; and
an actuator, wherein said actuator is mechanically coupled to said detachable floor surface.

2. The lid for a container as in claim 1, wherein said at least first internal wall, said first main body, said top surface and said detachable floor surface creates a first chamber.

3. The lid for a container as in claim 1, wherein said lid includes at least a second internal wall.

4. The lid for a container as in claim 3, wherein said at least second internal wall, said first main body, said top surface and said detachable floor surface creates a second chamber.

5. The lid for a container as in claim 1, wherein said actuator passes through said lid recess and is mechanically coupled to said detachable floor surface.

6. The lid for a container as in claim 1, wherein said actuator serves as a stirring element.

7. The lid for a container as in claim 1, wherein said container adaptable surface is configured to fix said lid on top of a container.

8. The lid for a container as in claim 1, wherein said actuator comprises a rigid portion, wherein said rigid portion comprises a less flexible material than the detachable floor surface.
